(19) United States
(12) Patent Application Publication
(10) Pub. No.: US 2009/0153326 A1
(43) Pub. Date: Jun. 18, 2009

(54) Method for locating intruder

(75) Inventors: Tewfik L. Doumi, Edison, NJ (US); Kiran M. Rege, Marlboro, NJ (US)

Correspondence Address: Jay M. Brown, 6409 Fayetteville Road, Suite 120-306, Durham, NC, 27713, US

(73) Assignee: Lucent Technologies, Inc., Murray Hill, NJ (US)

(21) Appl. No.: 12/001,865

(22) Filed: Dec. 13, 2007

(51) Int. Cl. G08B 13/00

(52) U.S. Cl. 340/541

(57) ABSTRACT

Method includes receiving plurality of measured signal strengths, computing estimated intruder signal strength associated with each of plurality of potential intruder locations, and selecting estimated intruder location. Receiving plurality of measured signal strengths includes receiving plurality of measured signal strengths each associated with sensor included in plurality of sensors distributed in monitored area that includes plurality of potential intruder locations. Selecting estimated intruder location includes selecting as estimated intruder location, first potential intruder location associated with estimated intruder signal strength greater than or equal to estimated intruder signal strength associated with another potential intruder location adjacent to first potential intruder location. Computer-readable medium containing code that executes method.

### BACKGROUND OF THE INVENTION

1. Field of the Invention

This invention generally relates to methods for detecting intruders.

2. Related Art

Various types of methods have been developed for detecting intruders. These methods may be utilized together with surveillance systems having sensors strategically deployed in a monitored area. Sensors include devices designed to translate a detectable intruder characteristic into a measurable signal. Sensors deployed in a surveillance system can include thermal imagers or infra-red sensors that are capable of detecting heat energy radiated by a human or animal intruder body, and converting the energy into an electrical signal. The electrical signal can then be further processed to estimate the location of an intruder, which facilitates taking appropriate action in response to the intrusion. Acoustic or optical sensors may be deployed to detect sound waves or light generated or reflected by an intruding human, animal, or other animate or inanimate object. Despite these developments, there is a continuing need for new methods of detecting intruders.

### SUMMARY

In an example of an implementation, a method is provided. The method includes receiving a plurality of measured signal strengths, computing an estimated intruder signal strength associated with each of a plurality of potential intruder locations, and selecting an estimated intruder location. Receiving a plurality of measured signal strengths includes receiving a plurality of measured signal strengths each associated with a sensor included in a plurality of sensors distributed in a monitored area that includes a plurality of potential intruder locations. Selecting an estimated intruder location includes selecting as an estimated intruder location, a first potential intruder location associated with an estimated intruder signal strength that is greater than or equal to an estimated intruder signal strength associated with another potential intruder location adjacent to the first potential intruder location.

As another example of an implementation, a computer-readable medium is provided. The computer readable medium contains computer code for execution by a system including a plurality of sensors distributed in a monitored area. When executed, the computer code is operable to cause the system to perform steps that include receiving a plurality of measured signal strengths, computing an estimated intruder signal strength associated with each of a plurality of potential intruder locations, and selecting an estimated intruder location. Receiving a plurality of measured signal strengths when the computer code is executed includes receiving a plurality of measured signal strengths each associated with a sensor included in a plurality of sensors distributed in a monitored area that includes a plurality of potential intruder locations. Selecting an estimated intruder location when the computer code is executed includes selecting as an estimated intruder location, a first potential intruder location associated with an estimated intruder signal strength that is greater than or equal to an estimated intruder signal strength associated with another potential intruder location adjacent to the first potential intruder location.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a schematic view showing an example of a surveillance system having a monitored area including a plurality of sensors.

FIG. 2 is a schematic view of a part of the monitored area of the example of a surveillance system shown in FIG. 1.

FIG. 3 is a schematic view showing four sensors together circumscribing a four-sided sensor polygon of monitored area, and three actual intruder locations outside the sensor polygon.

FIG. 4 is a flow chart showing an example of an implementation of a method.

FIG. 5 is a schematic view showing an example of a monitored area of a surveillance system with which the method shown in FIG. 4 may be utilized.

FIG. 6 is a graph plotting paths followed by a plurality of simulated intruders within a simulated monitored area having a plurality of simulated sensors, to be detected by the method shown in FIG. 4.

FIG. 7 is a graph plotting estimated intruder locations determined by applying the method shown in FIG. 4 to the measured signal strengths periodically reported by the simulated sensors as the simulated intruders follow the paths shown in FIG. 6.

### DETAILED DESCRIPTION

There are situations where a surveillance system including sensors deployed in a monitored area and where each sensor is configured for detecting intruders, may be inadequate to facilitate an effective response to one or more intruding humans, other animals, other animate or inanimate objects, or combinations of multiple types of intruders. For example, such a surveillance system may detect that an intrusion has occurred, but may be incapable of determining the location of an intruder of interest or of providing adequate information for tracking an intruder trajectory in the monitored area. In applications where surveillance of a large monitored area is needed, such as for controlling a long boundary between two property owners or a border between two countries, carrying out a timely response to an intrusion may depend on locating or tracking the trajectory of an intruder of interest. Locating an intruder of interest or tracking the intruder's trajectory may also facilitate more effective deployment of intrusion field response personnel, and may minimize diversion of personnel and other resources to false alarms or to non-threat intruders. Surveillance systems implemented for detecting an intrusion but incapable of locating or tracking trajectories of intruders of interest may be ineffective where multiple intruders of interest, mobile non-threat intruders such as wild animals, and environmental clutter such as trees and plants, are present in the monitored area. For example, surveillance systems depending on triangulation or trilateration of detected signals may be ineffective for analyzing an aggregate signal resulting from the detectable presence of multiple intruders, to identify their separate locations or trajectories and to distinguish intruders of interest from false alarms and from non-threat intruders.

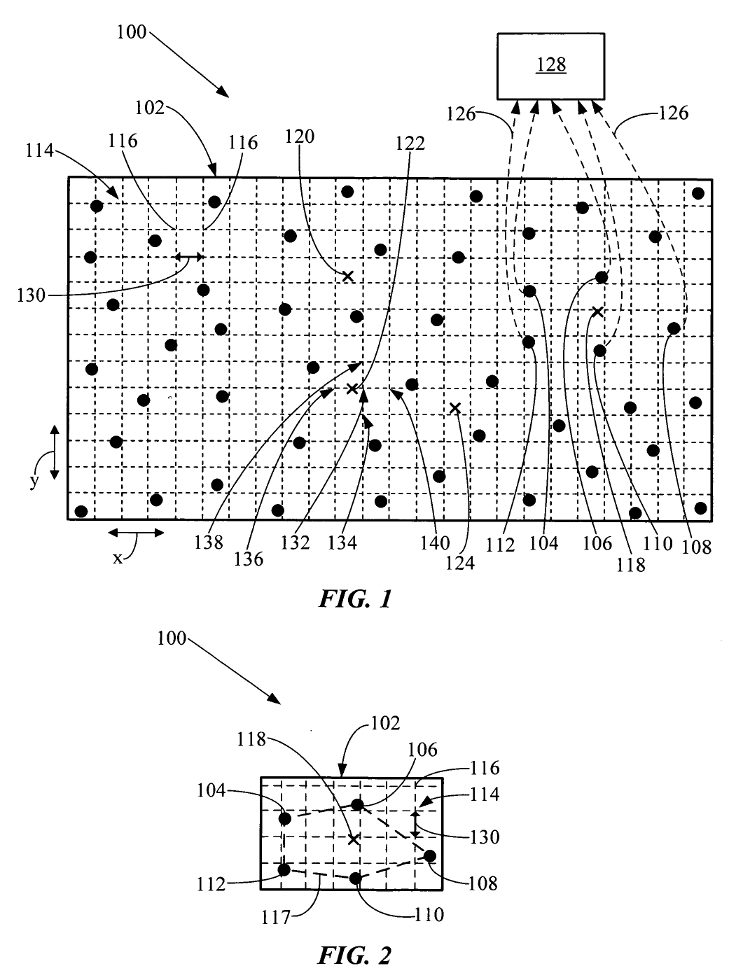

FIG. 1 is a schematic view showing an example 100 of a surveillance system having a monitored area 102 including a plurality of sensors 104, 106, 108, 110, 112. The example 100 of a surveillance system may, as an example, include a superimposed x, y grid 114 having a plurality of intersection points each defining a potential intruder location 116. Further (not shown), the grid 114 may be omitted, and the example 100 of a surveillance system may include a plurality of potential intruder locations 116 distributed in another arrangement within the monitored area 102, such as a random arrangement, or an array having a different orderly pattern. FIG. 1 further illustrates a plurality of intruders 118, 120, 122, 124. The presence of the intruder 118 in the monitored area 102 may, for example, result in detection of signals having measured strengths at each of the sensors 104, 106, 108, 110, 112 that are within a certain distance away from the intruder 118. The measured signal strengths may, for example, be relatively higher for sensors 106, 110, which are relatively closer than sensors 104, 108, 112 to the location of the intruder 118. The measured signal strengths detected by the sensors 104, 106, 108, 110, 112 and by other sensors in the monitored area 102 may be input as schematically indicated by the arrows 126 to a computing engine 128 which may be capable of processing the measured signal strengths and determining whether any intruders 118, 120, 122, 124 are present in the monitored area 102.

In an example of an implementation, a method is provided that is capable of processing measured signal strengths detected at sensors 104, 106, 108, 110, 112, to determine estimated intruder locations within a monitored area 102 of a surveillance system, such as the example 100 of a surveillance system shown in FIG. 1. The measured signal strengths may, for example, be both detected and measured by the sensors 104, 106, 108, 110, 112, or may be detected by the sensors 104, 106, 108, 110, 112 and measured elsewhere in the example 100 of a surveillance system. The term “measured signal strength” denotes a numerical value of the total signal strength detected by a sensor 104, 106, 108, 110, 112. The term “received signal strength” denotes a numerical value of the signal strength detected by a sensor 104, 106, 108, 110, 112 that is attributable to a particular intruder 118, 120, 122, 124. The method makes an assumption that the strength of a measured signal at a sensor 104, 106, 108, 110, 112 due to the presence of a given intruder 118, 120, 122, 124 within a monitored area 102 is inversely proportional to some power function of the distance between the intruder 118, 120, 122, 124 and the location of the sensor 104, 106, 108, 110, 112. The term “power function” denotes a mathematical equation including a value commonly referred to as an exponent. This power function may be expressed by the equation, ρ=P/d^{k}, where ρ denotes the received signal strength from the intruder 118, 120, 122, 124, where d is the distance between the intruder 118, 120, 122, 124 and the location of the sensors 104, 106, 108, 110, 112, where P is a constant value that is proportional to the signal strength of the intruder 118, 120, 122, 124, and where k is a path loss exponent that characterizes the operating environment of the example 100 of a surveillance system and a selected detection signal type that is utilized by the sensors 104, 106, 108, 110, 112. The constant value P is also referred to herein as an “estimated intruder signal strength”. The constant value P may be, for example, relatively larger for an adult human intruder than for a smaller intruder such as a bird or coyote. Both P and the path loss exponent k may be dependent on, for example, a selected detection signal type that is utilized by the sensors 104, 106, 108, 110, 112. As examples, the detection signal type may include electromagnetic radiation, acoustic waves, or heat. As further examples, the path loss exponent k may be a whole number or a decimal number within a range of between about two (2) and about five (5). A decimal number may have a selected number of significant figures, such as 2, 2.1, 2.11, 2.111 . . . In another example, the path loss exponent k may be about 2. Both k and typical values of P may be determined, for example, through calibration testing prior to deployment of the example 100 of a surveillance system.

The method may make a further assumption that when multiple intruders 118, 120, 122, 124 are present in the monitored area 102, then the measured signal strength detected at one of the sensors 104, 106, 108, 110, 112 is the sum of the received signal strengths ρ detected at that sensor 104, 106, 108, 110, 112 attributable to each of the intruders 118, 120, 122, 124. The method may, for example, further take into account the presence of sensor signal noise. Thus, if there are a total number N of intruders 118, 120, 122, 124 within a signal detection distance of one of the sensors 104, 106, 108, 110, 112, then the measured signal strength rₜₒₜₐₗ at the sensor 104, 106, 108, 110, 112, is expressed by the equation, rₜₒₜₐₗ=P₁/d₁^{k}+P₂/d₂^{k}+ . . . P_{N}/d_{N}^{k}+υ, where υ is a part of the measured signal strength rₜₒₜₐₗ that is associated with signal noise at one of the sensors 104, 106, 108, 110, 112, where P₁, P₂, . . . , P_{N} represent constant values proportional to the signal strength of each of the N intruders 118, 120, 122, 124 and where d₁, d₂, . . . , d_{N} are the corresponding distances between these N intruders 118, 120, 122, 124 and one of the sensors 104, 106, 108, 110, 112.

FIG. 2 is a schematic view of a part of the monitored area 102 of the example 100 of a surveillance system shown in FIG. 1, including the sensors 104, 106, 108, 110, 112, a superimposed grid 114 having intersections defining a plurality of potential intruder locations 116, and the intruder 118. For this discussion, the sensors 104, 106, 108, 110, 112 are respectively designated S1, S2, S3, S4 and S5; and the actual location of the intruder 118 marked by an “x”, is designated as point Z₀. The locations of the sensors S1, S2, S3, S4, S5 define vertices of an L-sided convex sensor polygon indicated by a dotted line 117, and point Z₀ marking the location of the intruder 118 is within the interior of the sensor polygon indicated by the dotted line 117. In this example, L equals 5. In the absence of other causes of a detectable signal such as sensor signal noise, the measured signal strength at each of the L sensors is expressed by the equation, rᵢ=P(Z₀)/dᵢ^{k}, where i=1, 2, . . . , L, where rᵢ denotes the measured signal strength at the i^{th} sensor, where dᵢ is the distance between the i^{th} sensor and the intruder 118 located at point Z₀, and where P(Z₀) is a constant value proportional to a signal strength of the intruder 118.

The method assumes that the example 100 of a surveillance system includes a plurality of potential intruder locations 116 mutually separated by a selected minimum distance, defining a resolution of the example 100 of a surveillance system. The example 100 of a surveillance system may include a two-dimensional x, y axis grid 114 having a plurality of intersection points each defining a potential intruder location 116 superimposed on the monitored area 102. As examples, adjacent potential intruder locations 116 may be separated by a minimum distance represented by the arrow 130 within a range of between about one (1) meter and about ten (10) meters, or by a distance of about 5 meters. The method utilizes the measured signal strengths at each of the L sensors to produce an estimated intruder location at a potential intruder location 116 determined to be the closest potential intruder location 116 to the actual intruder location point Z₀.

In estimating the location point Z₀ of the intruder 118, the method may assume that the path loss exponent “k” is known, along with the measured signal strengths r₁, r₂, . . . , r_{L}. As examples, a value for k may be estimated, arbitrarily selected, or determined by calibration testing as earlier discussed. The method may further assume that if the estimate of the location at point Z₀ of the intruder 118 is point Z and if the constant value proportional to the signal strength of the intruder 118 is P(Z), then the received signal strengths p at each of the L sensors S1, S2, S3, S4 and S5 that may be attributed to the intruder 118 at point Z and calculated according to the equation ρ=P/d^{k} cannot exceed the corresponding measured signal strengths rᵢ associated with the sensors S1, S2, S3, S4 and S5. This assumption may be expressed by the equation, P(Z)/[Dᵢ(Z)]^{k}≦rᵢ, for i=1, 2, . . . , L, and where Dᵢ(Z) is the distance between the estimated location at point Z of the intruder 118 and the i^{th} sensor S1, S2, S3, S4, S5. The preceding equation can be rewritten as the equation, P(Z)≦rᵢ [Dᵢ(Z)]^{k} for i=1, 2, . . . , L, constituting a constraint on the constant value P(Z) as a function of the estimated point Z of the location at point Z₀ of the intruder 118.

The equation rᵢ=P(Z₀)/dᵢ^{k} may be substituted into the equation, P(Z)≦rᵢ[Dᵢ(Z)]^{k}, yielding the substituted equation, P(Z)≦P(Z₀)[Dᵢ(Z)/dᵢ]^{k}, for i=1, 2, . . . , L, where dᵢ is the distance between the actual location at point Z₀ of the intruder 118 and the i^{th} sensor S1, S2, S3, S4, S5. Accordingly, P(Z) is less than or equal to each of the values P(Z₀)[Dᵢ(Z)/dᵢ]^{k} on the right side of the substituted equation for i=1, 2, . . . , L. Thus, if the estimated intruder location is the point Z within the sensor polygon indicated by the dotted line 117, then the estimated intruder signal strength P(Z) cannot exceed the smallest of the L quantities P(Z₀) [Dᵢ(Z)/dᵢ]^{k} on the right side of the equation.

When the estimated intruder location at point Z is a point in the interior of the sensor polygon indicated by the dotted line 117 other than the actual intruder location at point Z₀ also in the interior of the sensor polygon indicated by the dotted line 117, there must be at least one sensor Sᵢ for which Dᵢ(Z) is smaller than dᵢ. Therefore, P(Z) is smaller than P(Z₀) whenever the point Z is not the actual location point Z₀ of the intruder 118. However, when the point Z is the actual location point Z₀ of the intruder 118, then the estimated intruder signal strength P(Z) equals P(Z₀), since Dᵢ(Z) at the location point Z₀ is identical to dᵢ for all i. Hence, the actual location point Z₀ of the intruder 118 yields the highest estimated intruder signal strength P(Z₀) among all potential intruder location points Z. Accordingly, the method includes utilizing the measured signal strengths rᵢ associated with each of the L sensors S1, S2, S3, S4 and S5 to determine the estimated intruder signal strengths P(Z) for each point Z within the sensor polygon indicated by the dotted line 117, subject to the above constraints. The method may further include selecting a point Z corresponding to the highest calculated value for P(Z) as being the estimated intruder location point Z determined to be the closest potential intruder location 116 to the actual intruder location point Z₀. The selected resolution of the plurality of potential intruder locations 116 determines a minimum accuracy of the method. For example, the x, y grid 114 may have intersection points defining a maximum potential distance between the actual intruder location point Z₀ and a nearest potential intruder location 116 at an intersection on the grid 114. Selecting a plurality of potential intruder locations 116 such as the intersection points of an x, y grid 114 having a relatively finer resolution with relatively shorter minimum distances 130 between potential intruder locations 116 facilitates greater accuracy in determining estimated intruder location points Z. However, selecting a plurality of potential intruder locations 116 such as intersection points of an x, y grid 114 with such relatively shorter minimum distances 130 between potential intruder locations 116 makes correspondingly greater computing demands on the example 100 of a surveillance system in computing estimated intruder signal strengths P(Z) for each potential intruder location 116.

The above calculations for computing estimated intruder signal strengths P(Z) may be simplified as follows in carrying out the method. For each potential intruder location 116 also referred to as a potential intruder location point Z, let S(Z) denote the set of sensors Sᵢ, where i=1 . . . L, that are within a certain distance R away from the potential intruder location point Z. The distance R may be selected, for example, such that in the absence of non-intruder obstacles such as trees, plants, hillsides, and man-made structures, a sensor Sᵢ located at a distance less than or equal to R away from an intruder 118 can reliably detect a measurable signal strength rᵢ of which a significant part may be attributed to that intruder 118. For each sensor Sᵢ in the set S(Z) of sensors, let rᵢ(t) denote the measured signal strength rᵢ at the sensor Sᵢ at a signal measurement time instant t. Let the distance between the potential intruder location point Z and the sensor Sᵢ be denoted as Dᵢ(Z). Then, consistent with the calculations discussed above, the relationship at the signal measurement time instant t between the estimated intruder signal strength P(Z,t) of the intruder 118 and the measured signal strengths at sensors Sᵢ belonging to the set S(Z) may be represented by the following equation,

P(Z, t)=Min{[rᵢ(t)−α]Dᵢ(Z)^{k}}

where the expression on the right hand side of the equation represents the minimum value of the quantity [rᵢ(t)−α]Dᵢ(Z)^{k} determined over all sensors Sᵢ belonging to S(Z). The parameter α (“alpha”) is a signal correction factor that may, for example, represent sensor signal noise including thermal noise, and other measurement errors, that may be subtracted from the measured signal strengths rᵢ detected by the sensors S(Z). In another example, the signal correction factor α may address other measurement error factors, or the signal correction factor α may be omitted from the equation in computing P(Z,t). If for a sensor Sᵢ belonging to S(Z), the value of [rᵢ(t)−α] Dᵢ(Z)^{k} is found to be less than zero (0), then the estimated intruder signal strength P(Z,t) may, for example, be set to zero (0). As an example, the power functions Dᵢ(Z)^{k} may be computed for a monitored area 102 having a plurality of potential intruder locations 116 and having distributed sensors 104, 106, 108, 110, 112, during initialization of operation of the example 100 of a surveillance system and reused during successive intruder location estimation computations.

Having calculated the estimated intruder signal strength P(Z,t) as the minimum of [rᵢ(t)−α]Dᵢ(Z)^{k} over all sensors Sᵢ belonging to S(Z), the method may then identify local maxima of estimated intruder signal strengths P(Z,t), and may designate the corresponding potential intruder location points Z as estimated intruder locations. In an example, each of the estimated intruder signal strengths, P(Z, t), may be smoothed before the local maxima are identified. Smoothing may be carried out, for example, by a process that replaces the estimated intruder signal strength P(Z,t) associated with a potential intruder location point Z by a weighted average of the value of P(Z,t) that is associated with the potential intruder location point Z, together with the values of P(Z,t) associated with the potential intruder locations 116 at intersection points of the x, y grid 114 adjacent to the potential intruder location point Z. For example, referring to FIG. 1, the estimated intruder signal strength P(Z, t) for the potential intruder location point 132 may be replaced by a weighted average of estimated intruder signal strengths P(Z, t) corresponding to the potential intruder location point 132 and the adjacent potential intruder location points 134, 136, 138, 140.

Identification of a local maximum of estimated intruder signal strengths P(Z,t) and designation of the corresponding potential intruder location point Z as an estimated intruder location may be carried out by determining, as to each potential intruder location point Z, whether the associated estimated intruder signal strength P(Z, t) is greater than or equal to estimated intruder signal strengths P(Z, t) associated with adjacent potential intruder location points Z. For example, referring to FIG. 1, the potential intruder location point 132 may be considered to be an estimated intruder location if the estimated intruder signal strength P(Z, t) associated with the potential intruder location point 132 is greater than or equal to the estimated intruder signal strengths P(Z, t) associated with each of the adjacent potential intruder location points 134, 136, 138, 140.

The method may, for example, include selecting a minimum threshold value of estimated intruder signal strength P(Z, t) for the purpose of screening out estimated intruder location points Z that may be triggered by false alarms. For example, false alarms may be triggered by non-threat intruders or by sensor signal noise. As an example, a minimum threshold value τ (Tau) for an estimated intruder signal strength P(Z, t) may be used to screen out corresponding estimated intruder location points Z that may likely have been triggered by false alarms. If this screening is carried out, then a designation of an estimated intruder location point Z may, for example, be retained as such only if the corresponding estimated intruder signal strength P(Z, t) is greater than or equal to τ (Tau). Conversely, for example, a designation of a potential intruder location point Z as an estimated intruder location may be discarded if its associated estimated intruder signal strength P(Z, t) is less than τ (Tau). The resulting set of estimated intruder location points Z retained after this screening may then, for example, be designated as I(t).

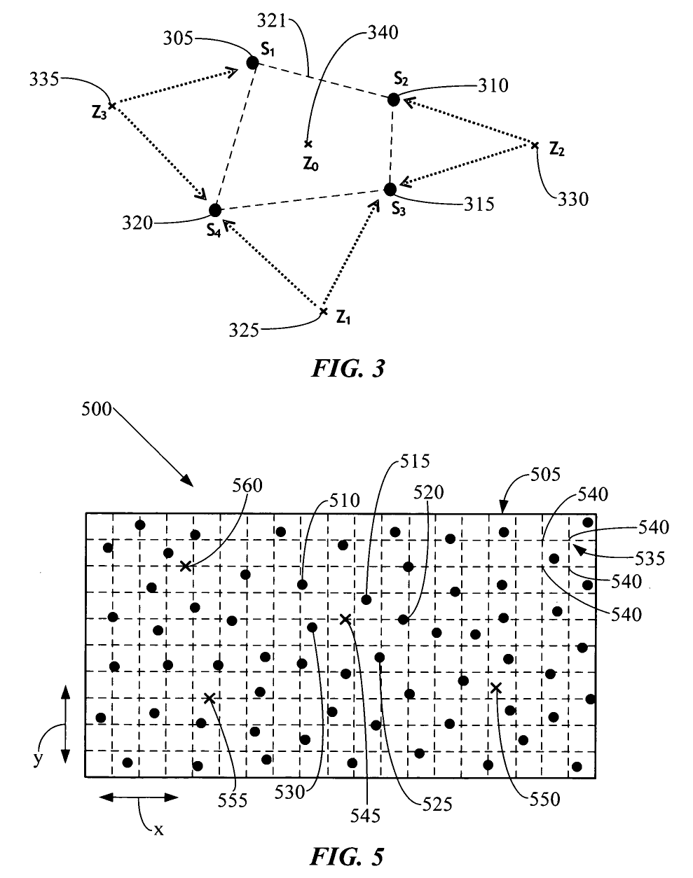

FIG. 3 is a schematic view showing four sensors 305, 310, 315, 320 together circumscribing a four-sided sensor polygon of monitored area indicated by a dotted line 321, and three actual intruder locations 325, 330, 335 outside the sensor polygon indicated by the dotted line 321. The three actual intruder locations 325, 330, 335 may be respectively designated as points Z₁, Z₂ and Z₃. The four sensors 305, 310, 315, 320 may be respectively designated as S₁, S₂, S₃ and S₄. The method described earlier for identifying estimated intruder location points Z may, for example, result in an inaccurate determination of an estimated intruder location 340 inside the sensor polygon indicated by the dotted line 321, at point Z₀.

The method may accordingly, for example, include carrying out estimate pruning to identify such falsely estimated intruder location points Z₀, and then deleting them from the set I(t). For each estimated intruder location point Z belonging to I(t), a set of sensors S(Z) may be identified that are within a distance R, as earlier defined, of the point Z. For each sensor Sᵢ belonging to S(Z), the combined received signal strengths p may be calculated corresponding to all estimated intruder location points Z belonging to I(t) excluding the estimated intruder location point Z.

This calculation may be expressed by the following equation,

ρ^{(other)}(i,Z)=Σ_{w}]P(W,t)/d^{k}(i,W)]

where σ^{(other)}(i, Z) represents the combined received signal strengths at sensor Sᵢ that correspond to all of the estimated intruder locations in I(t) other than the estimated intruder location point Z, where W represents a member of I(t) excluding point Z, where P(W,t) represents the estimated intruder signal strength associated with the estimated intruder location W, and where d(i,W) represents the distance between the sensor Sᵢ and the point W. The combined received signal strengths ρ^{(other)} corresponding to all estimated intruder locations W belonging to I(t) excluding the estimated intruder location point Z may then be subtracted from the measured signal strengths rᵢ at the sensors Sᵢ, to yield a residual measured signal strength r^{(res)} at each sensor Sᵢ. This residual measured signal strength r^{(res)} may be represented by the equation, r^{(res)}(i, Z)=rᵢ−ρ^{(other)}(i, Z). The residual measured signal strength r^{(res)}(i, Z) may be treated as an estimate of the received signal strength value ρ at sensor Sᵢ corresponding solely to the estimated intruder location point Z. The method may, for example, also include calculating an average value of r^{(res)}(i, Z) over all sensors Sᵢ within the set S(Z). The method may further define a threshold α as earlier discussed, for use in estimate pruning. For example, if the average value of r^{(res)}(i, Z) for a given estimated intruder location point Z over all sensors Sᵢ within the set S(Z) is less than the threshold α, then the estimated intruder location point Z may be deleted from the set I(t).

In an example, estimate pruning may be carried out in an iterative manner involving elimination in each pruning cycle of an estimated intruder location point Z associated with a smallest average value r^{(res)}(i, Z), to avoid a possibility where two estimated intruder locations might force each other to be pruned from I(t). The method may carry out this iterative process starting with a current set of estimated intruder locations I(t). For each estimated intruder location point Z in the set I(t), the average value r^{(res)}(i, Z) may be calculated as described above. The method may then identify a smallest of these average values r^{(res)}(i, Z) over all estimated intruder location points Z in the set I(t). If this smallest average value r^{(res)}(i, Z) is greater than or equal to α, then estimate pruning of the set I(t) may be terminated. If instead the smallest average value of R^{(res)}(i, Z) is smaller than α, then the estimated intruder location point Z corresponding to the smallest average value of r^{(res)}(i, Z) may be removed from the set I(t). The iterative estimate pruning process may then be repeated in the same manner as above, starting with the pruned set of estimated intruder location points I(t).

In another example, estimate pruning may be carried out in an iterative manner by calculating an average value of estimated intruder signal strengths P(Z, t) for each estimated intruder location point Z and then in each pruning cycle, segregating an estimated intruder location point Z that is associated with a current largest average value of P(Z,t) into a set B(t) of estimated intruder locations. The set B(t) may be empty before the first iteration of estimate pruning. The method may start the iterative pruning process by placing all of the estimated intruder locations I(t) into a set A(t). The method may then identify a largest average value P(Z,t) corresponding to one of the estimated intruder location points Z included in the set A(t). If the largest average value P(Z,t) associated with one of the potential intruder location points Z₁ in the set A(t) is greater than or equal to a selected threshold α, then that potential intruder location point Z₁ may be moved into the set B(t). In addition, the measured signal strengths for all sensors Sᵢ within a distance R away from that potential intruder location point Z₁ as earlier defined may then respectively be reduced by subtracting P(Z₁)/[Dᵢ(Z₁)]^{k}. The iterative estimate pruning process may then be repeated until either the set A(t) is empty, or the largest average value for P(Z,t) corresponding to one of the potential intruder location points Z remaining in the set A(t) is smaller than α. The estimate pruning process may then be terminated, with the set B(t) of potential intruder location points Z replacing the set I(t).

In a further example, the method may include estimate merging of the set I(t) or B(t) of estimated intruder location points Z. For example, referring to FIG. 1, if the set I(t) or B(t) includes estimated intruder location points Z at all of the contiguously located potential intruder location points 132, 134, 136, 138 and 140, then the method may include merging the estimated intruder locations at the contiguously located potential intruder location points 132, 134, 136, 138, and 140 into a single estimated intruder location at the potential intruder location point 132. In another example (not shown), a plurality of estimated intruder location points Z at a plurality of contiguously located potential intruder locations 116 at intersections of the grid 114 may be merged into a single estimated intruder location point Z at an approximate midway point among the plurality of contiguously located potential intruder locations 116.

The method may, for example, include measurement of signal strengths at each of a plurality of sensors Sᵢ at signal measurement time instants t separated by a selected time interval,

where i=1, 2, 3 . . . , L. L in this example is an integer designating the total number of sensors Sᵢ in the monitored area 102. As an example, the measured signal strengths rᵢ associated with the sensors Sᵢ may be periodically transmitted to the computing engine 128. Each of these periodic transmissions may effectively be a two-dimensional snapshot of the measured signal strengths rᵢ detected by the sensors Sᵢ distributed in a two-dimensional monitored area 102 at a signal measurement time instant t. The length of the time interval between the reported signal measurement time instants t may be selected, for example, as a compromise between computing and energy demands on the example 100 of a system, and intruder dynamics. As examples, shorter time intervals between reported signal measurement time instants t may result in greater energy consumption by the sensors Sᵢ, and may require relatively more estimated intruder location computations in a given elapsed time period. As another example, longer time intervals between reported signal measurement time instants t may reduce a relative accuracy of estimated intruder locations. However, the sensors Sᵢ may not all need to simultaneously record measured signal strengths, nor to simultaneously report such measured signal strengths to the computing engine 128. As another example, the method may include reporting of measured signal strengths to the computing engine 128 only when such measured signal strengths exceed a selected threshold, such as a sensor signal noise threshold α. The method may store and display estimated intruder locations associated with successive signal measurement time instants t. For example, the estimated intruder locations determined for a succession of signal measurement time instants t may be superimposed on a virtual display of the plurality of potential intruder locations 116 such as intersection points of an x, y grid 114 to facilitate assessment of intruder trajectories as well as of intruder locations. As another example, the estimated intruder locations and associated signal measurement time instants t may be processed through a path extraction analysis to separately plot paths of individual intruders.

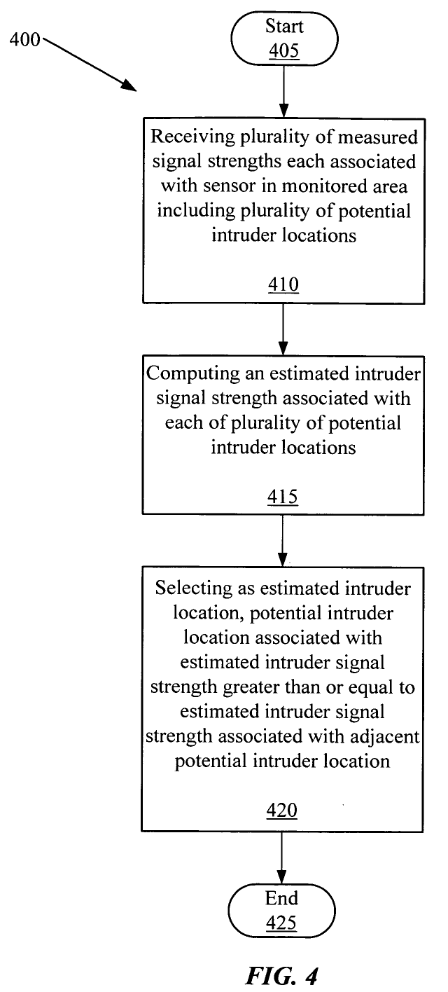

FIG. 4 is a flow chart showing an example of an implementation of a method 400. FIG. 5 is a schematic view showing an example 500 of a monitored area 505 of a surveillance system with which the method 400 shown in FIG. 4 may be utilized. FIG. 5 illustrates a plurality of sensors 510, 515, 520, 525, 530. The surveillance system may, as an example, include a superimposed x, y grid 535 defining intersection points each being a potential intruder location 540. In further examples (not shown), the surveillance system may include a plurality of potential intruder locations 540 distributed in an arrangement different than at intersection points of the grid 535 within the monitored area 505, such as a random distribution, or an array having a different orderly pattern. FIG. 5 further illustrates a plurality of intruders 545, 550, 555, 560. The method 400 starts at step 405. A plurality of measured signal strengths are received at step 410, each measured signal strength being associated with a sensor included in a plurality of sensors 510, 515, 520, 525, 530 distributed in a monitored area 505 including a plurality of potential intruder locations 540. At step 415, an estimated intruder signal strength associated with each of a plurality of potential intruder locations 540 is computed. Step 420 includes selecting as an estimated intruder location, a first potential intruder location 540 associated with an estimated intruder signal strength that is greater than or equal to an estimated intruder signal strength associated with another potential intruder location 540 adjacent to the first potential intruder location 540. The method may then end at step 425.

As an example, step 415 may include computing, for each of a plurality of potential intruder locations 540, a plurality of associated power functions each associated with a distance between the potential intruder location 540 and an associated sensor among a plurality of sensors 510, 515, 520, 525, 530. In that example, each such associated power function includes, as a power exponent, a path loss constant. Step 415 may further include computing, for each of a plurality of potential intruder locations 540, a plurality of associated products of each associated power function multiplied by the measured signal strength of the sensor 510, 515, 520, 525, 530 (minus a signal correction factor α) associated with the power function. Step 415 may additionally include utilizing the associated products to determine an estimated intruder signal strength associated with each of a plurality of potential intruder locations 540.

In another example, step 415 may include adjusting any negative computed associated product to a value of zero, and then selecting, as the estimated intruder signal strength associated with each of a plurality of potential intruder locations 540, a smallest associated product that includes an associated power function associated with a distance between the potential intruder location 540 and an associated sensor 510, 515, 520, 525, 530.

As another example, computing a plurality of associated power functions each associated with a distance between the potential intruder location 540 and an associated sensor 510, 515, 520, 525, 530 in step 415 may include selecting as the plurality of associated sensors 510, 515, 520, 525, 530, all sensors within a selected maximum distance from the potential intruder location 540.

As another example, step 420 may include merging together two estimated intruder locations having mutually adjacent potential intruder locations 540.

In a further example, step 420 may include selecting as an estimated intruder location, a potential intruder location 540 associated with an estimated intruder signal strength that is greater than or equal to a minimum threshold value.

As a further example, computing an estimated intruder signal strength in step 415 may include computing as the estimated intruder signal strength associated with a first potential intruder location 540, a weighted average of an estimated intruder signal strength associated with the first potential intruder location 540 and an estimated intruder signal strength associated with another potential intruder location 540 adjacent to the first potential intruder location 540.

As an additional example, selecting an estimated intruder location in step 420 may include computing an average estimated residual measured signal strength at a plurality of sensors 510, 515, 520, 525, 530 that is attributable to a first potential intruder location 540, and selecting the first potential intruder location 540 as an estimated intruder location if the average estimated residual measured signal strength is greater than or equal to a minimum threshold value.

In another example, selecting an estimated intruder location in step 420 may include identifying a maximum estimated intruder signal strength, selecting a corresponding potential intruder location 540 as an estimated intruder location if the maximum estimated intruder signal strength exceeds a defined minimum threshold value, and re-computing a plurality of estimated intruder signal strengths associated with potential intruder locations 540 excluding the selected estimated intruder location.

As an additional example, step 410 may include associating each of a plurality of measured signal strengths with a signal measurement time instant t, and step 415 may include associating each of a plurality of estimated intruder signal strengths with both a potential intruder location 540 and a signal measurement time instant t. As another example, step 420 may also include plotting the signal measurement time instants versus estimated intruder locations selected as being associated with estimated intruder signal strengths greater than or equal to a threshold value.

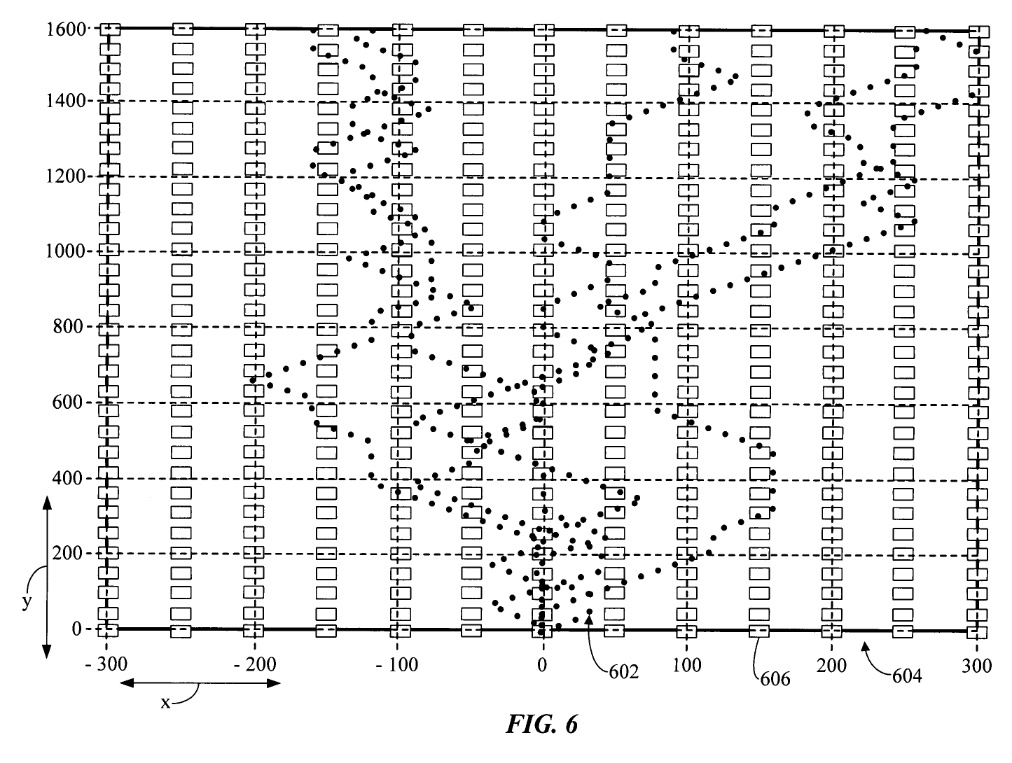

FIG. 6 is a graph plotting paths followed by a plurality of simulated intruders 602 within a simulated monitored area 604 having a plurality of simulated sensors 606, to be detected by the method shown in FIG. 4. The x-axis has units, from left to right, of distance in meters from West to East over a total of 600 meters across the monitored area 604. The y-axis has units, from bottom to top, of distance in meters from South to North over a total distance of 1,600 meters across the monitored area 604. An array including four hundred and three (403) simulated sensors 606, each indicated by a box, are placed within the simulated monitored area 604 at a uniform density of four hundred and forty eight (448) sensors 606 per square kilometer. Simulated locations of intruders 602 indicated by dots are updated at signal measurement time instants spaced apart by thirty (30) second intervals, over a total simulation testing period of one thousand and eighty (1,080) seconds.

In an example, a plurality of simulations of measured signal strengths are generated from the simulated intruders 602 and are received by the simulated sensors 606 schematically shown in FIG. 6, each measured signal strength being associated with one of the simulated sensors 606 and with a signal measurement time instant. The simulated monitored area 604 is configured in the same manner as discussed earlier with regard to the monitored area 102, with adjacent potential intruder locations being separated by a minimum point-to-point distance of five (5) meters. A plurality of associated power functions are computed, each associated power function being associated with a distance between the potential intruder location and an associated sensor 606 among a plurality of sensors 606. The associated sensors 606 are defined as all sensors 606 within a distance of 100 meters away from the potential intruder location. An assumed path loss constant of four (4) is used as the power exponent. For each of a plurality of potential intruder locations, a plurality of associated products are computed, each associated product including an associated power function multiplied by the measured signal strength of the sensor 606 (minus a signal correction factor α) associated with the power function. The associated products are utilized to determine an estimated intruder signal strength associated with each of a plurality of potential intruder locations. An estimated intruder location is selected, the selected estimated intruder location being a first potential intruder location associated with an estimated intruder signal strength that is greater than or equal to an estimated intruder signal strength associated with another potential intruder location adjacent to the first potential intruder location.

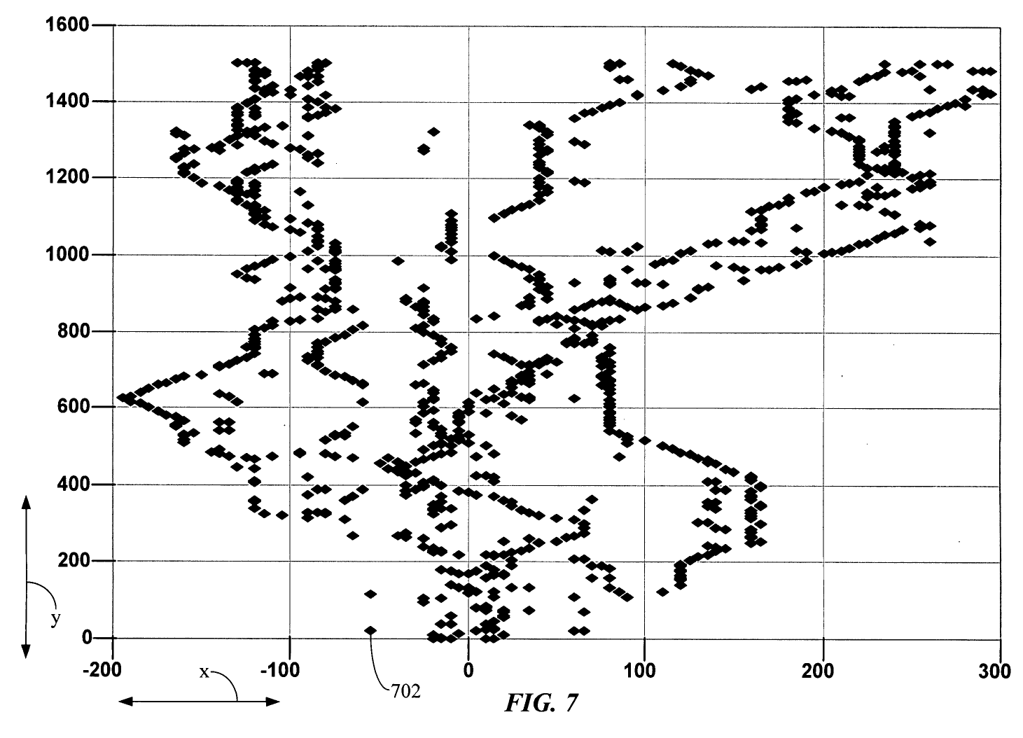

FIG. 7 is a graph plotting estimated intruder locations 702 indicated by dots, determined by applying the method shown in FIG. 4 to the measured signal strengths periodically reported by the simulated sensors 606, as the simulated intruders 602 follow the paths shown in FIG. 6. The x-axis of FIG. 7 has units in meters from left to right of distance from West to East across the monitored area 604. The y-axis of FIG. 7 has units in meters from bottom to top of distance from South to North across the monitored area 604. A correlation may be observed between the actual paths, indicated by dots, of the simulated intruders 602 shown in FIG. 6 and the estimated intruder locations 702, indicated by dots shown in FIG. 7.

Persons skilled in the art will understand and appreciate that one or more of the foregoing steps of the method 400 may be performed by execution of computer code contained in a computer-readable medium, such that when executed by a system including a plurality of sensors distributed in a monitored area that includes a plurality of potential intruder locations, the computer code is operable to cause the system to perform the method steps. Examples of computer-readable media include the following: an electrical connection (electronic) having one or more wires; a portable computer diskette (magnetic); a random access memory (RAM, electronic); a read-only memory “ROM” (electronic); an erasable programmable read-only memory (EPROM or Flash memory) (electronic); an optical fiber (optical); and a portable compact disc read-only memory “CDROM” “DVD” (optical). The computer-readable medium may be, as further examples, paper or another suitable medium upon which the program is printed, as the program may be electronically captured, via, for instance, optical scanning of the paper or other medium, then compiled, interpreted or otherwise processed in a suitable manner if necessary, and then stored in a computer memory.

The method 400 and the other methods discussed above may be utilized, for example, together with an intruder surveillance system, for analyzing a plurality of measured signal strengths each associated with a sensor included in a plurality of sensors distributed in a monitored area that includes a plurality of potential intruder locations. While the foregoing description refers in some instances to the method 400 and to other methods, it is understood by those skilled in the art that these methods may include additional steps and modifications of the indicated steps. Likewise, the method 400 and the other methods disclosed above may be performed utilizing any surveillance system including a plurality of sensors distributed in a monitored area that includes a plurality of potential intruder locations. The surveillance systems shown in FIGS. 1 and 5, and the other surveillance systems discussed above, are examples of surveillance systems that may be utilized. Sensors for inclusion in such surveillance systems may detect any characteristic of a potential target suitable to generate measurable signal strengths. As examples, sensors capable of detecting electromagnetic radiation or acoustic waves, or thermal imaging sensors, may be utilized. Electromagnetic radiation for detection by the sensors may include, as examples, infrared, visible, or microwave radiation.

Moreover, it will be understood that the foregoing description of numerous examples has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

What is claimed is:

1. A method, comprising:
receiving a plurality of measured signal strengths each associated with a sensor included in a plurality of sensors distributed in a monitored area that includes a plurality of potential intruder locations;
computing an estimated intruder signal strength associated with each of a plurality of potential intruder locations; and
selecting as an estimated intruder location, a first potential intruder location associated with an estimated intruder signal strength that is greater than or equal to an estimated intruder signal strength associated with another potential intruder location adjacent to the first potential intruder location.

2. The method of claim 1, including computing for each of a plurality of potential intruder locations, a plurality of associated power functions each associated with a distance between the potential intruder location and an associated sensor among a plurality of sensors, where each associated power function includes, as a power exponent, a path loss constant; computing for each of a plurality of potential intruder locations, a plurality of associated products of each associated power function multiplied by the measured signal strength of the sensor (minus a signal correction factor) associated with the power function; and utilizing the associated products to determine an estimated intruder signal strength associated with each of a plurality of potential intruder locations.

3. The method of claim 2, including adjusting any negative computed associated product to a value of zero, and then selecting, as the estimated intruder signal strength associated with each of a plurality of potential intruder locations, a smallest associated product that includes an associated power function associated with a distance between the potential intruder location and an associated sensor.

4. The method of claim 2, where computing a plurality of associated power functions each associated with a distance between the potential intruder location and an associated sensor includes selecting as the plurality of associated sensors, all sensors within a selected maximum distance from the potential intruder location.

5. The method of claim 1, including merging together two estimated intruder locations having mutually adjacent potential intruder locations.

6. The method of claim 1, including selecting as an estimated intruder location, a potential intruder location associated with an estimated intruder signal strength that is greater than or equal to a minimum threshold value.

7. The method of claim 1, including computing as the estimated intruder signal strength associated with a first potential intruder location, a weighted average of an estimated intruder signal strength associated with the first potential intruder location and an estimated intruder signal strength associated with another potential intruder location adjacent to the first potential intruder location.

8. The method of claim 1, including computing an average estimated residual measured signal strength at a plurality of sensors that is attributable to a first potential intruder location, and selecting the first potential intruder location as an estimated intruder location if the average estimated residual measured signal strength is greater than or equal to a minimum threshold value.

9. The method of claim 1, including identifying a maximum estimated intruder signal strength, selecting a corresponding potential intruder location as an estimated intruder location if the maximum estimated intruder signal strength exceeds a defined minimum threshold value, and re-computing a plurality of estimated intruder signal strengths associated with potential intruder locations excluding the selected estimated intruder location.

10. The method of claim 1, including associating each of a plurality of measured signal strengths with a signal measurement time instant, and including associating each of a plurality of estimated intruder signal strengths with both a potential intruder location and a signal measurement time instant.

11. The method of claim 10, including plotting the signal measurement time instants versus estimated intruder locations selected as being associated with estimated intruder signal strengths greater than or equal to a threshold value.

12. A computer-readable medium, the computer readable medium containing computer code that, when executed by a system including a plurality of sensors distributed in a monitored area including a plurality of potential intruder locations, is operable to cause the system to perform steps comprising:
receiving a plurality of measured signal strengths each associated with a sensor included in a plurality of sensors distributed in a monitored area that includes a plurality of potential intruder locations;
computing an estimated intruder signal strength associated with each of a plurality of potential intruder locations; and
selecting as an estimated intruder location, a first potential intruder location associated with an estimated intruder signal strength that is greater than or equal to an estimated intruder signal strength associated with another potential intruder location adjacent to the first potential intruder location.

13. The computer-readable medium of claim 12, further containing computer code that, when executed by such a system, is operable to cause such a system to perform steps that include computing for each of a plurality of potential intruder locations, a plurality of associated power functions each associated with a distance between the potential intruder location and an associated sensor among a plurality of sensors, where each associated power function includes, as a power exponent, a path loss constant; computing for each of a plurality of potential intruder locations, a plurality of associated products of each associated power function multiplied by the measured signal strength of the sensor (minus a signal correction factor) associated with the power function; and utilizing the associated products to determine an estimated intruder signal strength associated with each of a plurality of potential intruder locations.

14. The computer-readable medium of claim 13, further containing computer code that, when executed by such a system, is operable to cause such a system to perform steps that include adjusting any negative computed associated product to a value of zero, and then selecting, as the estimated intruder signal strength associated with each of a plurality of potential intruder locations, a smallest associated product that includes an associated power function associated with a distance between the potential intruder location and an associated sensor.

15. The computer-readable medium of claim 13, further containing computer code that, when executed by such a system, is operable to cause such a system to perform steps that include computing a plurality of associated power functions each associated with a distance between the potential intruder location and an associated sensor whereby all sensors within a selected maximum distance from the potential intruder location are selected as the plurality of associated sensors.

16. The computer-readable medium of claim 12, further containing computer code that, when executed by such a system, is operable to cause such a system to perform steps that include merging together two estimated intruder locations having mutually adjacent potential intruder locations.

17. The computer-readable medium of claim 12, further containing computer code that, when executed by such a system, is operable to cause such a system to perform steps that include selecting as an estimated intruder location, a potential intruder location associated with an estimated intruder signal strength that is greater than or equal to a minimum threshold value.

18. The computer-readable medium of claim 12, further containing computer code that, when executed by such a system, is operable to cause such a system to perform steps that include computing as the estimated intruder signal strength associated with a first potential intruder location, a weighted average of an estimated intruder signal strength associated with the first potential intruder location and an estimated intruder signal strength associated with another potential intruder location adjacent to the first potential intruder location

19. The computer-readable medium of claim 12, further containing computer code that, when executed by such a system, is operable to cause such a system to perform steps that include computing an average estimated residual measured signal strength at a plurality of sensors that is attributable to a first potential intruder location, and selecting the first potential intruder location as an estimated intruder location if the average estimated residual measured signal strength is greater than or equal to a minimum threshold value

20. The computer-readable medium of claim 12, further containing computer code that, when executed by such a system, is operable to cause such a system to perform steps that include identifying a maximum estimated intruder signal strength, selecting a corresponding potential intruder location as an estimated intruder location if the maximum estimated intruder signal strength exceeds a defined minimum threshold value, and re-computing a plurality of estimated intruder signal strengths associated with potential intruder locations excluding the selected estimated intruder location.
